(19) United States
(12) Patent Application Publication
(10) Pub. No.: US 2026/0356362 A1
(43) Pub. Date: Nov. 12, 2026

(54) VEHICLE AND A METHOD FOR CONTROLLING SAME

(71) Applicants: HYUNDAI MOTOR COMPANY, Seoul (KR); KIA CORPORATION, Seoul (KR)

(72) Inventor: Kyung Joo Bang, Hwaseong-si (KR)

(73) Assignees: HYUNDAI MOTOR COMPANY, Seoul (KR); KIA CORPORATION, Seoul (KR)

(21) Appl. No.: 19/542,287

(22) Filed: Feb. 17, 2026

(30) Foreign Application Priority Data
May 7, 2025 (KR) 10-2025-0059048

(51) Int. Cl. B60W 30/165; B60W 60/00

(52) U.S. Cl. CPC B60W 30/165; B60W 60/001; B60W 2520/14; B60W 2552/10; B60W 2554/4041; B60W 2554/4042; B60W 2554/802; B60W 2754/30

(57) ABSTRACT

An autonomous vehicle control device may include: a memory storing at least one instruction; and one or more processors connected to the memory, wherein the instruction, when executed by the one or more processor, is configured to cause the autonomous vehicle control device to: generate an expected traveling trajectory of the autonomous vehicle based on a yaw rate of the autonomous vehicle being controlled to follow a front vehicle, and determine whether the front vehicle deviates from the expected traveling trajectory based on position information of the front vehicle. In particular, the processor is configured to determine, when the front vehicle deviates from the expected traveling trajectory, whether to maintain following control to follow the front vehicle based on the position information of the front vehicle and the position information of a surrounding vehicle adjacent to the front vehicle, and control the autonomous vehicle based on a result of the determination.

### CROSS-REFERENCE TO RELATED APPLICATION

This application claims priority to Korean Patent Application No. 10-2025-0059048 filed on May 7, 2025, the disclosure of which is incorporated herein by reference in its entirety.

### FIELD OF TECHNOLOGY

Various embodiments of the present disclosure relate to an autonomous vehicle and a method of controlling an autonomous vehicle.

### BACKGROUND

The statements in this section merely provide background information related to the present disclosure and may not constitute prior art.

An existing smart cruise control (SCC) system recognizes a front vehicle by combining information from a front camera and a radar, but it is difficult to accurately distinguish a lane in which a surrounding vehicle is traveling. It is difficult for the camera to accurately recognize a lane at a far distance, and the radar is not capable of detecting lane information.

As a result, it is possible to erroneously recognize a vehicle in an adjacent lane as a target to follow in a curved road entry or exit section, and in particular, the risk of an accident due to sudden braking may increase in a congestion situation near an entry/exit ramp.

### SUMMARY

The present disclosure addresses the problems described above and aims to determine whether to continue following a front vehicle through changes in road shape, based on a traveling trajectory and the relative position of a surrounding vehicle.

The problems to be solved by the present disclosure are not limited to the above-mentioned problems, and other problems that are not mentioned will be clearly understood by a person skilled in the art from the following description.

According to an embodiment of the present disclosure, an autonomous vehicle control device may comprise: a memory configured to store at least one instruction; and one or more processors connected to the memory. In particular, the processor may be configured to: generate an expected traveling trajectory of the autonomous vehicle based on a yaw rate of the autonomous vehicle being controlled to follow a front vehicle; determine whether the front vehicle deviates from the expected traveling trajectory based on position information of the front vehicle; determine, when the front vehicle deviates from the expected traveling trajectory, whether to maintain following control to follow the front vehicle based on the position information of the front vehicle and position information of a surrounding vehicle adjacent to the front vehicle, and control the autonomous vehicle based on a result of the determination of whether to maintain the following control.

In some embodiments of the present disclosure, when the following control to follow the front vehicle is terminated, the processor may be configured to control the autonomous vehicle to follow the surrounding vehicle or determine whether to deactivate the following control.

In some embodiments of the present disclosure, the surrounding vehicle may be a vehicle located on the expected traveling trajectory or a vehicle positioned within a preset distance from the expected traveling trajectory.

In some embodiments of the present disclosure, when the autonomous vehicle is traveling in a section having a curvature less than or equal to a preset first curvature value and is scheduled to enter a section having a curvature greater than or equal to a second curvature value that is greater than the first curvature value, the processor may be configured to maintain the following control to follow the front vehicle, when the front vehicle is spaced apart by a distance less than or equal to a preset longitudinal distance with reference to a surrounding vehicle positioned within a predetermined distance from the expected traveling trajectory.

In some embodiments of the present disclosure, when the autonomous vehicle is traveling in a section having a curvature less than or equal to a preset first curvature value and is scheduled to enter a section having a curvature greater than or equal to a second curvature value that is greater than the first curvature value, the processor may be configured to terminate the following control when the front vehicle is spaced apart by a distance greater than a preset longitudinal distance with reference to a surrounding vehicle positioned within a predetermined distance from the expected traveling trajectory.

In some embodiments of the present disclosure, the processor may be configured to follow the surrounding vehicle, when the surrounding vehicle has a speed less than or equal to a predetermined speed; when a time for determining whether to maintain the following control to follow the front vehicle exceeds a preset time limit; or when the autonomous vehicle deviates from a lane in which the autonomous vehicle is currently traveling.

In some embodiments of the present disclosure, when the autonomous vehicle is traveling in a section having a curvature greater than or equal to a preset second curvature value and is scheduled to enter a section having a curvature less than or equal to a first curvature value that is less than the second curvature value, the processor may be configured to maintain the following control to follow the front vehicle when the front vehicle is spaced apart by a distance greater than or equal to a preset lateral distance with reference to a surrounding vehicle positioned within a predetermined distance from the expected traveling trajectory.

In some embodiments of the present disclosure, when the autonomous vehicle is traveling in a section having a curvature greater than or equal to a preset second curvature value and is scheduled to enter a section having a curvature less than or equal to the first curvature value that is less than the second curvature value, the processor may be configured to terminate the following control to follow the front vehicle when the front vehicle is spaced apart by a distance less than a preset lateral distance with reference to a surrounding vehicle positioned within a predetermined distance of the expected traveling trajectory.

In some embodiments of the present disclosure, the processor may be configured to follow the surrounding vehicle when the surrounding vehicle has a speed less than or equal to a predetermined speed; when a time for determining whether to maintain the following control to follow the front vehicle exceeds a preset time limit; or when the autonomous vehicle deviates from a lane in which the autonomous vehicle is currently traveling.

In some embodiments of the present disclosure, the processor may be configured to output a notification via an input-output interface of the autonomous vehicle when the following control to follow the front vehicle is terminated, or when the surrounding vehicle is set as a new target vehicle for the following control.

According to an embodiment of the present disclosure, a method of controlling an autonomous vehicle may comprise: generating an expected traveling trajectory of the autonomous vehicle based on a yaw rate of the autonomous vehicle being controlled to follow a front vehicle; determining whether the front vehicle deviates from the expected traveling trajectory based on position information of the front vehicle; in response to a determination that the front vehicle deviates from the expected traveling trajectory, determining whether to maintain following control of the front vehicle based on the position information of the front vehicle and position information of a surrounding vehicle adjacent to the front vehicle, and controlling the autonomous vehicle based on a result of the determination of whether to maintain following control of the front vehicle.

The method according to some embodiments of the present disclosure may further comprise: controlling the autonomous vehicle to follow the surrounding vehicle or determining whether to deactivate the following control, in response to the termination of the following control of the front vehicle.

In some embodiments of the present disclosure, the surrounding vehicle may be a vehicle located on the expected traveling trajectory or a vehicle positioned within a preset distance from the expected traveling trajectory.

In some embodiments of the present disclosure, determining whether to maintain the following control may comprise: in response to a determination that the autonomous vehicle is traveling in a section having a curvature less than or equal to a preset first curvature value and is scheduled to enter a section having a curvature greater than or equal to a second curvature value that is greater than the first curvature value, maintaining the following control of the front vehicle based on a determination that the front vehicle is spaced apart by a distance less than or equal to a preset longitudinal distance with reference to the surrounding vehicle.

In some embodiments of the present disclosure, determining whether to maintain the following control may comprise: in response to a determination that the autonomous vehicle is traveling in a section having a curvature less than or equal to a preset first curvature value and is scheduled to enter a section having a curvature greater than or equal to a second curvature value that is greater than the first curvature value, terminating the following control based on a determination that the front vehicle is spaced apart by a distance greater than a preset longitudinal distance with reference to the surrounding vehicle.

The method according to some embodiments of the present disclosure may further comprise: following the surrounding vehicle based on a determination that the surrounding vehicle has a speed less than or equal to a predetermined speed and that at least one of the following conditions is satisfied: i) a time for determining whether to maintain the following control of the front vehicle exceeds a preset time limit, and ii) the autonomous vehicle deviates from a lane in which the autonomous vehicle is currently traveling.

In some embodiments of the present disclosure, determining whether to maintain the following control may comprise: in response to a determination that the autonomous vehicle is traveling in a section having a curvature greater than or equal to a preset second curvature value and is scheduled to enter a section having a curvature less than or equal to a first curvature value that is less than the second curvature value, maintaining the following control of the front vehicle based on a determination that the front vehicle is spaced apart by a distance greater than or equal to a preset lateral distance with reference to the surrounding vehicle.

In some embodiments of the present disclosure, determining whether to maintain the following control may comprise: in response to a determination that the autonomous vehicle is traveling in a section having a curvature greater than or equal to a preset second curvature value and is scheduled to enter a section having a curvature less than or equal to a first curvature value that is less than the second curvature value, terminating the following control of the front vehicle based on a determination that the front vehicle is spaced apart by a distance less than a preset lateral distance with reference to a surrounding vehicle positioned within a predetermined distance of the expected traveling trajectory.

The method according to some embodiments of the present disclosure may further comprise: following the surrounding vehicle based on a determination that the surrounding vehicle has a speed less than or equal to a predetermined speed and that at least one of the following conditions is satisfied: i) a time for determining whether to maintain the following control of the front vehicle exceeds a preset time limit, and ii) the autonomous vehicle deviates from a lane in which the autonomous vehicle is currently traveling.

The method according to some embodiments of the present disclosure may further comprise: outputting, via an input-output interface of the autonomous vehicle, a notification indicating that the following control of the front vehicle is terminated or that the surrounding vehicle is set as a new target vehicle for the following control.

According to an embodiment of the present disclosure, by determining whether to follow front vehicle based on the traveling trajectory of the own vehicle and the positions of the front vehicle and a surrounding vehicle, lane information of the front vehicle can be confirmed, and the accuracy of the front vehicle following control can be improved.

The effects of the present disclosure are not limited to the above-mentioned effects, and other effects that are not mentioned should be clearly understood by a person skilled in the art from the following description.

### BRIEF DESCRIPTION OF THE DRAWINGS

FIG. 1 is a schematic diagram illustrating an autonomous vehicle according to an embodiment.

FIG. 2 is a flowchart illustrating a process for determining a following control of an autonomous vehicle according to an embodiment of the present disclosure.

FIG. 3 is a flowchart illustrating a process of a following control operation in a case of entering a curved road from a straight road according to an embodiment of the present disclosure.

FIG. 4 is a schematic diagram illustrating the operation of FIG. 3.

FIG. 5 is a flowchart illustrating a following control operation in a case of entering a straight road from a curved road according to an embodiment of the present disclosure.

FIG. 6 is a schematic diagram illustrating the operation of FIG. 5.

### DETAILED DESCRIPTION

Hereinafter, some embodiments of the present disclosure are described in detail with reference to the accompanying drawings.

However, the technical spirit of the present disclosure is not limited to the some embodiments to be described, but may be implemented in various different forms, and within the scope of the technical spirit of the present disclosure, one or more of the constituent elements may be selectively combined or substituted between embodiments.

Furthermore, the terms (including technical and scientific terms) used in the embodiments of the present disclosure, unless specifically defined otherwise, should be interpreted as having the meaning generally understood by one of ordinary skill in the art to which the present disclosure pertains. Commonly used, predefined terms should be interpreted based on their contextual meaning in the relevant art.

In addition, the terms used in the embodiments of the present disclosure are for the purpose of describing the embodiments and are not intended to limit the present disclosure.

In this specification, the singular form may include the plural form unless the context clearly indicates otherwise, and when described as “at least one (or one or more) of A, B, or C,” it may include at least one of all possible combinations of A, B, and C.

Furthermore, in describing the components of the embodiments of the present disclosure, terms such as first, second, A, B, (a), (b), etc., may be used.

These terms are only for distinguishing one component from another, and the essence, order, or sequence of the corresponding component is not limited by these terms.

And, when a component is described as being ‘connected’, ‘coupled’, or ‘joined’ to another component, it may include not only the case where the component is directly connected, coupled, or joined to the other component, but also the case where it is ‘connected’, ‘coupled’, or ‘joined’ through another component existing between the component and the other component.

In addition, when described as being formed or placed “on (top of) or under (below)” each component, on (top of) or under (below) includes not only the case where the two components are in direct contact with each other but also the case where one or more other components are formed or placed between the two components. Also, when expressed as “on (top of) or under (below),” it may include the meaning of not only the upward direction but also the downward direction with respect to one component.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

In the various flowcharts of the present disclosure, at least some of the steps may be omitted or their mutual order may be changed, and at least some of the various embodiments of the present disclosure may be performed at a specific point in time of each step of the flowcharts. The operations of the various flowcharts in the present disclosure may be performed by at least one of control device 100, processor 130, and autonomous vehicle 10. In addition, redundant content in the drawings of the present disclosure may be omitted. In this document, ‘control device 100’ may also be referred to as ‘autonomous vehicle control device 100’.

‘Driver control assistance system’ in the present disclosure may refer to hardware and software that can help a driver continuously control the longitudinal and lateral movements of a vehicle. This driver control assistance system may be referred to as an ‘autonomous driving system’ or ‘system’ in the present disclosure.

‘Feature’ mentioned in the present disclosure may refer to the function of a specific system that provides assistance to the driver in a defined traffic scenario, situation, and system boundary.

‘Dynamic Control’ mentioned in the present disclosure may refer to performing the operational and tactical functions necessary to move the vehicle in real time. This may include control of the vehicle's lateral and longitudinal movements, monitoring of the road environment, responding to events in the road traffic environment, operational planning, and signaling.

‘System Boundaries’ mentioned in this document may refer to verifiable or measurable limits or conditions set by the manufacturer, up to or within the conditions that affect the ability of a system or the function of a system designed to provide assistance to a driver and the system to operate as intended.

Each step of the flowcharts described in the present disclosure may be performed by the control device 100 of the autonomous vehicle 10, but is not limited thereto, and processor 130, at least one instruction stored in storage unit 120, or autonomous vehicle 10 itself may also perform the embodiments of each step. For example, The processor 130 may execute the instructions to cause the autonomous vehicle 10 to perform each step.

Hereinafter, embodiments are described in detail with reference to the accompanying drawings; however, the same or corresponding components may be given the same reference numbers regardless of the drawing numbers, and redundant descriptions thereof have been omitted.

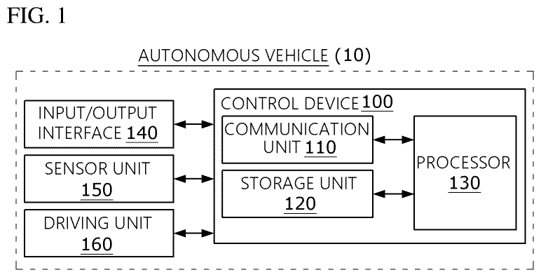

FIG. 1 is a schematic diagram illustrating an autonomous vehicle 10 according to an embodiment.

The autonomous vehicle 10 may include: the control device 100, a communication unit 110, the storage unit 120, the processor 130, an input-output interface 140, a sensor unit 150, and a driving unit 160. Each of these components in FIG. 1 may be implemented within the vehicle.

The autonomous vehicle 10 may be dynamically controlled in various driving situations through an autonomous driving system. For example, the autonomous driving system can provide both driving stability and convenience through longitudinal control (acceleration and deceleration) and lateral control (lane keeping and lane changing) of the autonomous vehicle 10. This autonomous driving system monitors the driving environment through sensors and control devices, and processes data in real time to adjust the vehicle's position, driving speed, direction, and so on.

The control device 100 may be formed integrally with the internal components of the vehicle, or it may be implemented as a separate, independent device from the other components inside of the autonomous vehicle 10 and communicate with the internal components of the vehicle through various connection means (e.g., CAN bus, wireless network, wired connection, etc.). The control device 100 includes the communication unit 110, the storage unit 120, and the processor 130 to manage the vehicle's longitudinal and lateral control, and may additionally include other components such as the input-output interface 140, the sensor unit 150, and the driving unit 160 to perform complex control functions according to the driving situation.

The control device 100 may store data collected from the sensor unit 150 during driving in the storage unit 120 and process it in real time to control the vehicle's safety and convenience functions. For example, the control device may perform overall control and management of the autonomous driving system, such as providing a notification in a situation where driver intervention is required based on the data detected from sensor unit 150.

The control device 100 may display the vehicle control status or receive a driver input to control driving functions through a user interface linked with an HMI (Human-Machine Interface) based on various driver settings and driving conditions.

According to an embodiment of the present disclosure, the control device 100 may generate a traveling trajectory and compare it with the position information of a front vehicle and at least one surrounding vehicle to determine whether the front vehicle that the autonomous vehicle 10 is following has actually changed lanes or merely appears to have changed due to the road shape. The control device 100 may determine whether to maintain or terminate following control of the front vehicle based on this determination.

The communication unit 110 performs communication with other control devices inside the vehicle to share data between systems, or transmits and receives various information through a connection with the outside of the vehicle. The communication unit 110 uses various in-vehicle communication methods such as CAN (Controller Area Network) communication and Ethernet to transmit control signals and data between internal components, and can link driving information and external data in real time through communication with a user terminal, other vehicles (V2V: Vehicle-to-Vehicle), infrastructure (V2I: Vehicle-to-Infrastructure), or an external server.

The communication unit 110 can perform short-range communication, GNSS (Global Navigation Satellite System) communication (e.g., via a GPS module), V2X (Vehicle-to-Everything) communication, optical communication, broadcast transmission and reception, and ITS (Intelligent Transport Systems) communication functions. For example, the communication unit 110 can support stable data transmission at close range using various wireless communication technologies such as Bluetooth, RFID (Radio Frequency Identification), IrDA (Infrared Data Association), UWB (Ultra Wideband), ZigBee, NFC (Near Field Communication), Wi-Fi, Wi-Fi Direct, and Wireless USB. In addition, it can perform long-distance communication through mobile communication modules based on mobile communication networks such as LTE and 5G and wireless internet modules to improve the performance of the autonomous driving system by receiving real-time data or linking with the cloud.

According to an embodiment of the present disclosure, the communication unit 110 may receive the current position information and moving speed information of a front vehicle or surrounding vehicles through V2V or V2I communication. In addition, the communication unit 110 may also receive the current position information and moving speed information of the front vehicle or the surrounding vehicles through a centralized server.

The storage unit 120 may include various types of memory that can store data, and may be integrated within the control device 100 or processor 130 or configured as a separate module. The storage unit 120 may include a non-volatile memory (e.g., a hard disk drive, a flash memory, EEPROM, SRAM, FRAM, PRAM, MRAM, etc.) and a volatile memory (e.g., DRAM, SDRAM, DDR-SDRAM, etc.), and can combine these to implement a memory system with various capacities and performances.

According to one embodiment, the storage unit 120 may include a memory that can store and manage various data related to the autonomous driving system.

According to an embodiment of the present disclosure, the storage unit 120 may store point information related to road shape change sections and position history data of a front vehicle or surrounding vehicles. The road shape change section may include, for example, a section where the road changes from straight t (i.e., a straight road) to curve (i.e., a curved road), or from a curved road to a straight road.

According to an embodiment of the present disclosure, the storage unit 120 may provide a memory including at least one instruction. The instructions may be configured to be executed by the processor 130 to perform various control operations for the front vehicle following control of autonomous vehicle 10.

The instructions may be configured to generate an expected traveling trajectory based on a yaw rate value of autonomous vehicle 10. The expected traveling trajectory may refer to a path that the vehicle is predicted to follow in the future, based on the vehicle's current traveling direction and degree of rotation.

The instructions may be configured to compare the position information of the front vehicle obtained from the communication unit 110 or the sensor unit 150 with the expected traveling trajectory to determine whether the front vehicle has deviated from the expected traveling trajectory.

In addition, the instructions may be configured to determine whether to maintain the following control for the front vehicle based on the position information of the front vehicle and the position information of the surrounding vehicle(s), when the front vehicle has deviated from the expected traveling trajectory.

The instructions may be configured to set a surrounding vehicle that is included in the expected traveling trajectory or located within a predetermined distance as a new target vehicle for following, when it is determined that the following control is to be terminated.

In addition, the instructions may be configured to output, via the input-output interface 140, a notification to the driver indicating whether to terminate the following control or whether to set a new vehicle for following.

The subject of the operations performed in the following drawings may be the processor 130, the autonomous vehicle control device 100, the autonomous vehicle 10, or the instructions.

The processor 130 is configured to communicate with various internal components of autonomous vehicle 10 such as the communication unit 110, the storage unit 120, the input-output interface 140, the sensor unit 150, and the driving unit 160 through electrical or operational connections, and The processor 130 is further configured to control the operation of each component and perform data processing. The processor 130 may be a central processing unit configured to execute commands and calculate data, and also collect, process, and analyze data in real time according to the vehicle's driving environment to perform the vehicle control.

The processor 130 may be implemented in the form of hardware, software, or a combination thereof, and may perform vehicle control logic in the form of, for example, a microcontroller, FPGA, or ASIC. In addition, it may include a multi-processor configuration for the control of complex autonomous driving and driver assistance systems. This processor configuration can support comprehensive vehicle control and stable performance through the execution of autonomous driving and assistance systems, sensor data processing, communication data management, and driving-related determination functions.

According to an embodiment of the present disclosure, the processor 130 may generate an expected traveling trajectory based on the yaw rate of autonomous vehicle 10. The processor 130 may compare the traveling trajectory with the position information of a front vehicle and at least one surrounding vehicle to determine whether the front vehicle has actually changed lanes. The processor 130 may maintain or terminate the following control according to this determination result. In addition, when terminating the following control, the processor 130 may set a new surrounding vehicle as a following target.

The input-output interface 140 plays a role in receiving input related to vehicle control from the user and delivering the vehicle's control status and system operation information to the user. The input-output interface 140 may be implemented as a hardware device and/or software module configured to receive user input and provide system output.

The input-output interface 140 is configured to perform the function of receiving various inputs from the user and delivering the vehicle control status to the user. For example, the input-output interface 140 may include at least one of the following: input through physical buttons provided inside autonomous vehicle 10, input through soft buttons displayed on the display of autonomous vehicle 10, user's voice input, and user's gesture input.

According to an embodiment of the present disclosure, the input-output interface 140 may notify the driver visually or audibly when the following control for a front vehicle is terminated or when the target vehicle for following is changed. The input-output interface 140 may display the results of autonomous driving determinations such as termination of following and selection of a new vehicle in real time, or output them in the form of voice or vibration.

The input means may include physical buttons, soft keys on a touch display, a voice recognition function, a gesture recognition function, etc., through which the user can input commands such as an autonomous driving system activation request, function switching, or driving assistance settings.

In addition, the input means may receive user input through an input device provided on a steering wheel of the autonomous vehicle 10. For example, through buttons mounted on the steering wheel, the driver can input a command to activate or deactivate the autonomous driving system even while driving. This steering wheel-based input can support the user to quickly control autonomous driving functions by providing an intuitive interface.

The output means includes a display, an audio module (e.g., speakers), a haptic module, etc., and can provide the user with the status of the autonomous driving system, a control transfer request notification, a function activation status, etc., in visual, audible, and tactile forms.

In addition, the status of the autonomous driving system can be intuitively checked through a head-up display (HUD), a cluster, AVN (Audio Video Navigation), and displays built into the rear-view mirror or side mirrors. In addition, the status of the autonomous driving system can be checked through the display of a console installed in each row of autonomous vehicle 10, an application on a user terminal, and so on.

The sensor unit 150 may include a number of sensors that support the stable operation of the autonomous driving system by detecting various driving and environmental information in real time. The sensor unit 150 may measure the distance and speed to surrounding objects through long-range detection sensors such as RADAR (Radio Detection and Ranging) and LIDAR (Light Detection and Ranging), and may include ultrasonic sensors to detect objects near the autonomous vehicle 10.

In addition, sensor unit 150 includes position sensors such as GPS to collect the position information of autonomous vehicle 10, and includes optical sensors to provide surrounding illuminance information so that the system can respond to changes in light. In addition, the sensor unit 150 may include accelerator and decelerator pedal sensors, a steering wheel detection sensor, a seating sensor, etc., to monitor the driving control status of the autonomous vehicle 10 and user actions.

The sensor unit 150 may include a camera. The camera may be classified into an external camera and an internal camera. The external camera recognizes the road and surrounding environment, and the internal camera can comprehensively grasp the situation inside and outside the vehicle by detecting the driver's state (e.g., eye tracking, drowsiness detection) or the indoor situation.

The sensor unit 150 may include a heart rate sensor, a pressure sensor, an infrared sensor, etc., to collect the driver's biometric information or various environmental data.

According to an embodiment of the present disclosure, the sensor unit 150 may detect the yaw rate value of the autonomous vehicle 10 and collect position data of a front vehicle and at least one surrounding vehicle through a radar or lidar sensor. The sensor unit 150 may provide the collected position data to control the device 100 to be used for selecting a target for following control.

The driving unit 160 is configured to provide the driving force necessary for the driving of the autonomous vehicle 10 and may include various components that control the vehicle's operation according to the command output from the control device 100. The driving unit 160 may include devices that generate and transmit the vehicle's power, such as an engine, a motor, a transmission, a wheel drive system, etc., and a controller that controls them, and through these components, acceleration, deceleration, and direction change of the autonomous vehicle 10 can be performed.

The driving unit 160 can be controlled to maintain driving safety by performing longitudinal control (acceleration and deceleration) and lateral control (lane keeping and lane changing) of the vehicle. For example, it receives a command from the control device 100 to adjust the output of the motor or adjust the rotation speed and direction of the wheels so that the vehicle can follow the driving path.

In addition, the driving unit 160 includes a brake system to reduce the vehicle speed or stop during driving. The driving unit 160 can control the autonomous vehicle 10 through control via an electric motor in the case of an electric vehicle, and based on engine output in the case of an internal combustion engine vehicle.

According to an embodiment of the present disclosure, the driving unit 160 may perform operations such as acceleration/deceleration or lane change when the target vehicle for following is changed according to the command of the control device 100. The driving unit 160 can dynamically adjust the speed and direction of the vehicle toward the new target vehicle for following.

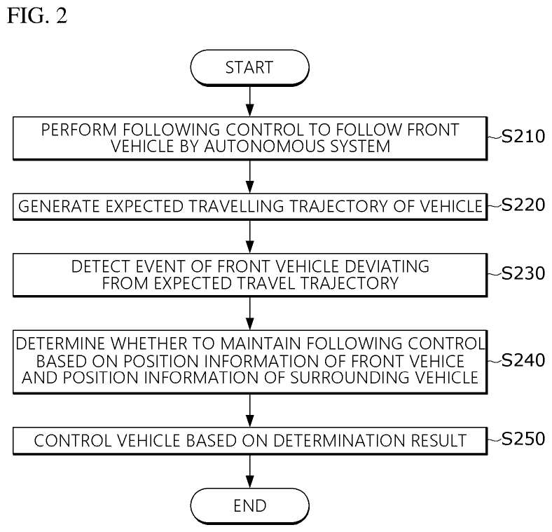

FIG. 2 is a flowchart illustrating a process for determining a following control of an autonomous vehicle according to an embodiment of the present disclosure.

The control device 100 may control the autonomous vehicle 10 to follow the front vehicle by the autonomous driving system (in a step S210).

The control device 100 may control an operation of the autonomous vehicle 10, such as acceleration, deceleration, stopping, and steering, based on the position and speed of the front vehicle while the autonomous vehicle 10 is traveling. This front vehicle following control is one of the basic driving functions of the autonomous driving system and may include longitudinal control and lateral control of the autonomous vehicle 10.

The control device 100 may receive the position information of the front vehicle through the sensor unit 150 or perform communication with an external vehicle through the communication unit 110 to recognize the position of the front vehicle. This location information is obtained through sensors such as radar, lidar, camera, and GPS and may be used to calculate a relative distance and a relative speed between the autonomous vehicle 10 and the front vehicle.

The control device 100 may generate a control instruction to maintain a target interval (e.g., a predetermined distance) between the autonomous vehicle 10 and the front vehicle according to the control logic stored in the storage unit 120 and transmit the generated instruction to the driving unit 160 to control driving of the vehicle.

The control device 100 may generate an expected traveling trajectory of the autonomous vehicle 10 based on a yaw rate of the autonomous vehicle 10 (in a step S220).

The yaw rate is a value representing a horizontal rotational speed of the autonomous vehicle 10 and may be used to determine whether the autonomous vehicle 10 is traveling in a curved line or a straight line (i.e., along a curved path or a straight path). The control device 100 may calculate a trajectory in which the autonomous vehicle 10 is to travel in a short term based on data such as the speed, the steering angle, the current position, and the traveling direction of the vehicle together with the yaw rate value.

The expected traveling trajectory may include, for example, a sequence of coordinates and may include an expected path for a certain distance or time from a reference position of the autonomous vehicle 10. This trajectory is calculated in a form similar to the actual traveling trajectory and may be updated in real time according to the curvature of the road, the current steering state, and the vehicle speed.

In addition, the control device 100 may also refer to the past travel history of the autonomous vehicle 10 or road structure data recorded in the storage unit 120 to consider a change situation in which the road shape is switched from a straight line to a curved line or from a curved line to a straight line.

The control device 100 may detect, based on the position information of a front vehicle, a state in which the front vehicle has deviated from the expected traveling trajectory of the autonomous vehicle 10 (in a step S230). In other words, the control device 100 may determine, using position information of the front vehicle, that the front vehicle has deviated from the expected traveling trajectory of the autonomous vehicle 10.

The position information of the front vehicle may include distance and direction information obtained through the sensor unit 150, or data such as position coordinates and speed received through the communication unit 110. The control device 100 may compare the position information of the front vehicle with the expected traveling trajectory and confirm whether the position information is included in the trajectory or not.

This comparison may be performed by setting a longitudinal distance reference and a lateral distance reference between the coordinate sequence of the expected traveling trajectory generated with reference to the autonomous vehicle 10 and the current position of the front vehicle. For example, when the front vehicle is spaced apart from the center line of the trajectory by a predetermined lateral distance or more, or is positioned outside the trajectory range, it may be determined that the vehicle has deviated from the trajectory.

It is also possible to determine whether the front vehicle is in a state of changing the lane, based on the movement direction or an amount of change in the trajectory slope of the vehicle located in front of the control device 100. This determination may also be carried out in situations where the road changes or transitions from a curved line (e.g., a curved path) to a straight line (e.g., a straight path), or changes from a straight line to a curved line. In this way, the control device 100 may monitor not only the position information of the front vehicle or the surrounding vehicle(s), but also the traveling trajectory of the front vehicle and the surrounding vehicle(s).

The control device 100 may determine whether to maintain the following control of the autonomous vehicle 10 based on the expected traveling trajectory of the autonomous vehicle 10, the position information of the front vehicle, and the position information of the surrounding vehicle (in a step S240).

The control device 100 may refer to the position data of the front vehicle and the surrounding vehicle collected through the sensor unit 150 or the communication unit 110. After it is detected or determined that the front vehicle has deviated from the expected traveling trajectory of the autonomous vehicle 10, the control device 100 may determine whether to maintain the following control by comparing the relative positional relationship between the front vehicle and the surrounding vehicle located near the expected traveling trajectory.

Specifically, the control device 100 may determine whether the front vehicle has deviated from the longitudinal and lateral references based on the position of the surrounding vehicle located within a predetermined distance from the expected traveling trajectory. Even if the front vehicle has deviated from the expected traveling trajectory, when it is determined that there is a possibility of maintaining the following in accordance with the relative position with the surrounding vehicle, the determination of whether to continue following may be temporarily suspended.

This determination may be utilized in sections where the road transitions from straight to curved (i.e., from a straight road to a curved road), from curved to straight (i.e., from a curved road to a straight road), or complex road environments where lane changes frequently occur, or the like.

The control device 100 may control the autonomous vehicle 10 based on a result of determining whether to maintain the following control (in a step S250).

When it is determined to maintain the following control in step S240, the control device 100 may generate a control instruction to follow the existing front vehicle as it is and transmit the control instruction to the driving unit 160. At this time, the driving unit 160 may perform longitudinal control of the vehicle to execute an acceleration or deceleration operation, and may perform steering control to keep the vehicle at the center of the lane through lateral control when necessary.

When it is determined to terminate the following control for the front vehicle, the control device 100 may select one of the two controls described below.

When a new vehicle satisfying a predetermined condition among the surrounding vehicles is reselected as a following target (e.g., a new target vehicle to follow), the control device 100 may switch the driving control of the autonomous vehicle 10 based on the position and speed of the new vehicle.

When there is no new following target, the control device 100 may deactivate the following control and continue to perform autonomous driving while maintaining a certain safety interval or may switch control authority to the driver.

In addition, the control device 100 may provide the major determination result, such as the change in the following target or the termination of the following control, to the driver in the form of a notification through the input-output interface 140. The notification may be generated and output in one or more of the following manners: visual, audible, or haptic.

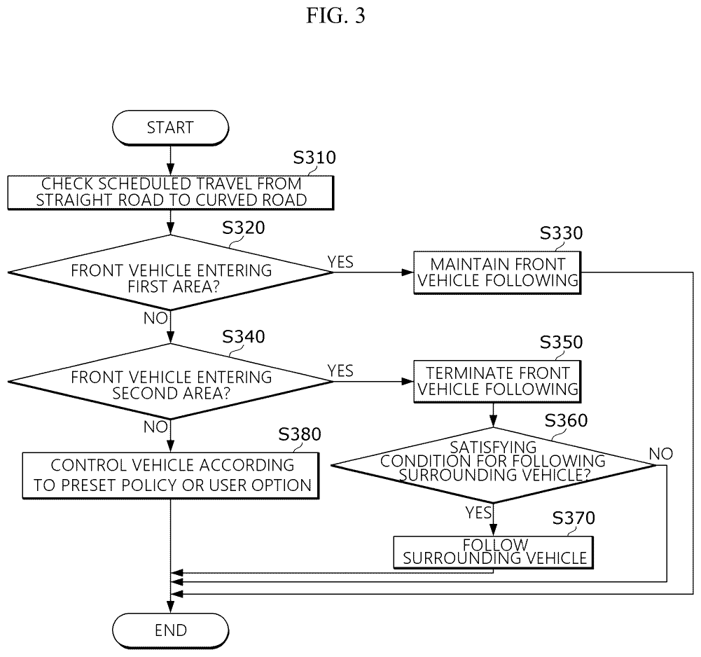

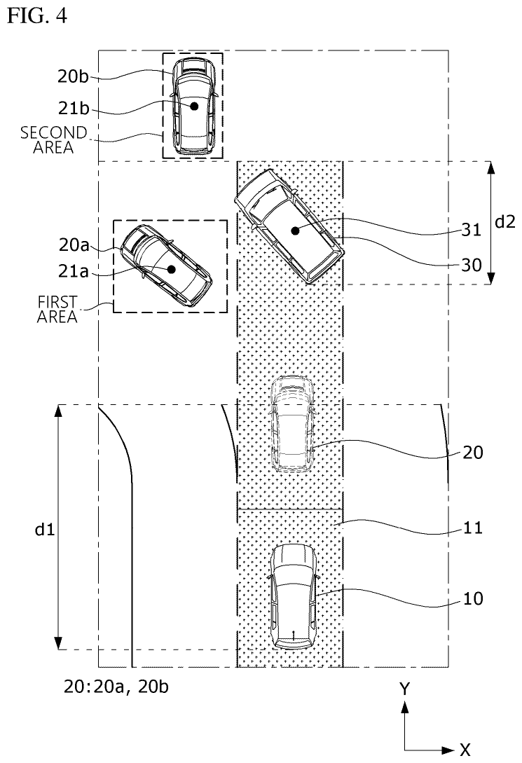

FIG. 3 is a flowchart illustrating the process of performing a following control as the vehicle 10 enters a curved road from a straight road according to an embodiment of the present disclosure. FIG. 3 is described with reference to FIG. 4. FIG. 4 shows a diagram illustrating the operation of FIG. 3.

The control device 100 may check a situation in which traveling from a straight road to a curved road is scheduled (in a step S310).

The processor 130 may estimate the shape of the traveling road based on the road map information stored in the storage unit 120 and the information on the autonomous vehicle 10 such as the current position, the traveling direction, and the yaw rate. According to this determination, the control device 100 may determine whether the vehicle 10 is scheduled to enter a curved road from the current straight road. In addition, the control device 100 may estimate the switching point of the road shape by analyzing, in real time, the trend in curvature change rate, the steering angle, and the yaw rate.

According to an embodiment of the present disclosure, a situation in which a vehicle is scheduled to transition from a straight road to a curved road may be determined based on a curvature value. For example, when the curvature of the road on which the autonomous vehicle 10 is currently traveling is less than or equal to a preset first curvature value, and it is expected that the curvature of the road into which the vehicle is to enter is greater than or equal to a second curvature value, it may be determined that the autonomous vehicle 10 is entering a curved road. In this case, the second curvature value may be set to be greater than the first curvature value.

Referring to FIG. 4, the autonomous vehicle 10 is traveling along a straight road and is at a point in time where a curved road is present ahead, and the vehicle is about to enter the curved road. The control device 100 may generate the expected traveling trajectory 11 based on the yaw rate of the autonomous vehicle 10 regardless of the actual road shape. Therefore, although the road shape in FIG. 4 changes from a straight line to a curved line, the expected traveling trajectory 11 may still be formed in a straight line based on the yaw rate of the current autonomous vehicle 10.

The control device 100 may utilize the road shape information stored in the storage unit 120 or the real-time sensor data to determine whether the curved road is in a predetermined state. In other words, the control device 100 may use the road shape information stored in the storage unit 120 or real-time sensor data to determine whether entry into a curved road is scheduled. For example, referring to FIG. 4, it is confirmed that the traveling trajectory continues from the straight road to the curved road section ahead, and accordingly, it may be determined that a transition from a straight-line to a curved-line travel is scheduled.

In FIG. 4, a recognition distance d1 may be a section indicating a range of distances perceivable only by the sensor unit 150 of the autonomous vehicle 10. For example, there may be a limitation that the camera is difficult to recognize far lanes, and the radar is impossible to distinguish lanes. As a result, the autonomous vehicle 10 may obtain relatively accurate lane information only for road conditions within the recognition distance d1.

The control device 100 may confirm that the autonomous vehicle 10 is currently scheduled to enter a curved road from a straight road by determining whether the front vehicle 20 has deviated from the trajectory and whether the road shape is changed within the perceivable distance d1.

In FIG. 3, the control device 100 may determine whether the front vehicle 20 has entered first area (in a step S320).

The control device 100 may determine whether the vehicle is included in the first area based on the current position information of the front vehicle 20 received through the sensor unit 150 or the communication unit 110.

The first area may refer to a case in which, when the front vehicle has deviated from the expected traveling trajectory 11, the vehicle is positioned within a preset distance d2 in the longitudinal direction with reference to the position of the surrounding vehicle 30 and is spaced apart by a preset distance or more in the lateral direction.

Referring to FIG. 4, in a state where the expected traveling trajectory 11 is generated based on the travel of the autonomous vehicle 10, the front vehicle 20 may move to a specific position after deviating from the trajectory. At this time, the surrounding vehicle 30 may be present at a position that partially overlaps with the expected traveling trajectory 11 of the autonomous vehicle 10. Any reference point 21a for calculating the relative position of the front vehicle 20a is positioned in the range of the longitudinal margin distance d2 from the reference point 31 of the surrounding vehicle 30. In addition, in the lateral direction, the distance may be a predetermined multiple (e.g., 1.5 times) or more than the width of the current traveling lane of the autonomous vehicle 10.

The control device 100 may determine such a situation as the entry of the front vehicle 20a into the first area. In this case, since the front vehicle 20a may temporarily appear out of the trajectory due to the shape of the road, there is a possibility that the lane is not actually changed. Accordingly, when it is determined that the front vehicle 20a is included in the first area, the control device 100 may proceed with maintaining the following control (in a step S330).

In FIG. 3, the control device 100 may determine whether the front vehicle 20 has entered the second area (in a step S340).

The control device 100 may determine whether the position of the front vehicle 20 is spaced apart by a distance greater than a preset longitudinal distance, with reference to the surrounding vehicle 30 located within a predetermined distance from the expected traveling trajectory 11.

Referring to FIG. 4, the front vehicle 20b that has deviated from the trajectory may be in a state of being spaced apart beyond a longitudinal distance d2 set with reference to any point 31 of the surrounding vehicle 30. As in the case of the first area, in this case, the surrounding vehicle 30 may be present in a position that partially overlaps the expected traveling trajectory 11 of the autonomous vehicle 10. In this situation, the control device 100 may determine that the front vehicle has likely changed lanes and that another surrounding vehicle has appeared on the expected trajectory.

As described above, the control device 100 may determine that the front vehicle 20 has entered the second area when the front vehicle 20 is at a position ahead of the reference position of the surrounding vehicle 30 by a certain margin distance in the longitudinal direction and when the front vehicle is spaced apart by less than a predetermined multiple (e.g., 1.5 times) of the width of the traveling lane of the autonomous vehicle 10 in the lateral direction.

When it is determined that the front vehicle has entered the second area, the control device 100 may control the autonomous vehicle 10 to terminate the following control (in a step S350).

When the following of the front vehicle is terminated, the control device 100 may determine the surrounding vehicle as a new front vehicle and determine whether the following condition is satisfied (in a step S360).

After the following control of the front vehicle 20 is terminated, the control device 100 may determine the surrounding vehicle 30 as a new control candidate (e.g., a target candidate to follow). For this purpose, the control device 100 may determine whether the position of the surrounding vehicle is included in the expected traveling trajectory 11 of the autonomous vehicle 10 or is positioned within a preset distance from the expected traveling trajectory.

In addition, the control device 100 may determine whether the speed of the surrounding vehicle is less than or equal to a predetermined speed. In addition, it may be determined that the condition is satisfied when the time for determining whether to follow exceeds the set time limit or when it is detected that the autonomous vehicle 10 is out of the currently traveling lane. When one or more of these conditions are satisfied, the control device 100 may consider the surrounding vehicle as a new front vehicle and set the surrounding vehicle as the following control target (in a step S370).

When the following condition for the surrounding vehicle is not satisfied, the control device 100 may terminate the operation of the present disclosure, temporarily suspend the following determination, switch the autonomous vehicle 10 to a manual driving mode, or perform a predefined standby operation according to a user setting.

When it is determined that the front vehicle has entered neither the first area nor the second area (“NO” in the step S340), the control device 100 may control the autonomous vehicle 10 according to a preset policy or a user option (in a step S380).

The control device 100 may determine that the relative positional relationship with the surrounding vehicle is unclear when it is confirmed that the front vehicle has deviated from the trajectory but the vehicle belongs to neither the first area nor the second area. In this case, the control device 100 may temporarily suspend the following determination, switch the autonomous vehicle 10 to a manual driving mode, or perform a predefined standby operation according to a user setting.

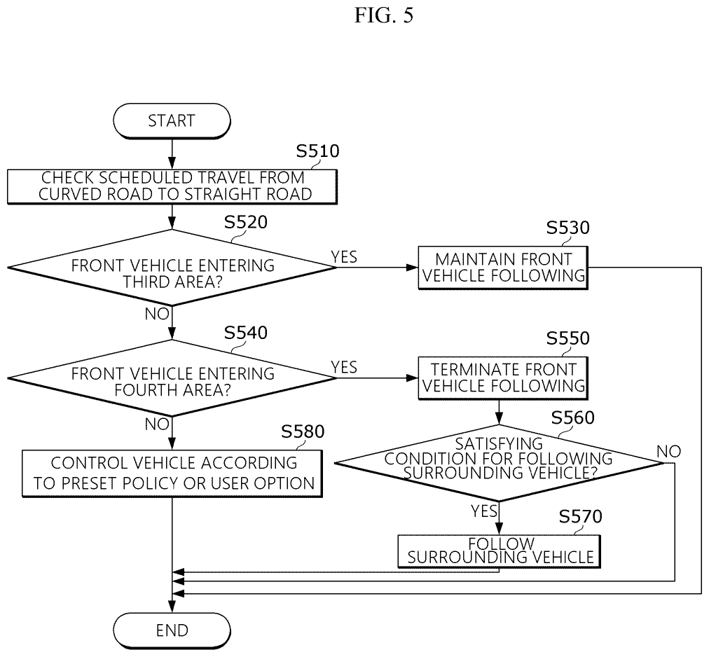

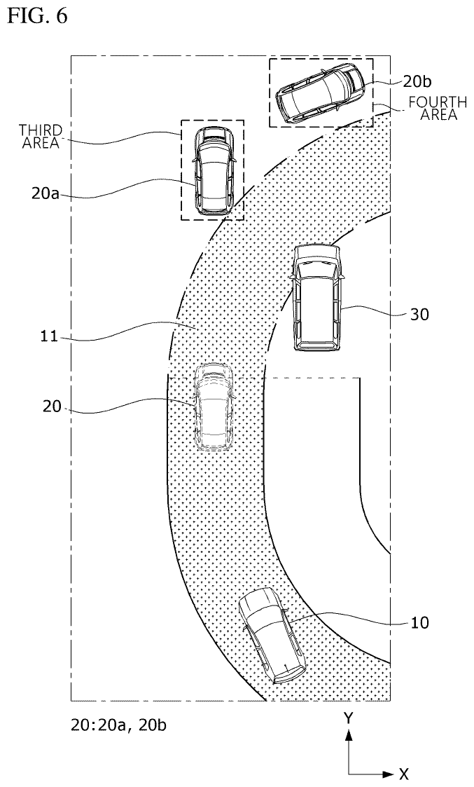

FIG. 5 is a flowchart illustrating a process of performing a following control in a case of entering a straight road from a curved road according to an embodiment of the present disclosure. FIG. 5 is described with reference to FIG. 6. FIG. 6 is a schematic diagram illustrating the operation of FIG. 5.

The control device 100 may confirm a situation in which a change from a curved road to a straight road is scheduled (in a step S510).

The control device 100 may confirm the expected traveling section of the autonomous vehicle 10 by referring to the road map data recorded in the storage unit 120 or the road route information obtained from the sensor unit 150. The road change schedule confirmation may be performed based on a change in curvature of a traveling trajectory of the autonomous vehicle 10, straightening of a road boundary line, or the like.

In addition, the processor 130 may determine that the autonomous vehicle 10 is entering a straight road from a curved road when the curvature of the current traveling trajectory of the autonomous vehicle 10 gradually decreases and a section in which the road shape is straightened after a specific point is continuously detected.

According to an embodiment of the present disclosure, a situation in which traveling from a curved road to a straight road is scheduled may be determined based on a curvature value. For example, in a state where the curvature of the road on which the autonomous vehicle 10 is currently traveling is greater than or equal to a preset second curvature value, when it is expected that the curvature of the road that the vehicle is entering decreases to be less than or equal to the first curvature value, it may be determined that the autonomous vehicle 10 is entering a straight road. In this case, the second curvature value may be set to be greater than the first curvature value. In addition, the processor 130 may calculate the change in the curvature value based on the change in the yaw rate and the change in the steering angle. In addition, the processor 130 may detect a change in the curvature value using the camera.

Referring to FIG. 6, the autonomous vehicle 10 is currently traveling on a curved road and is moving along a trajectory of entering a straight road in the top direction of the drawing. In the example illustrated in FIG. 6, the expected traveling trajectory 11 of the autonomous vehicle 10 is expressed in a form in which the curvature gradually decreases by reflecting the road shape that extends along a curve and then extends along a straight line. Regardless of this change in the shape of the road, the expected traveling trajectory 11 of FIG. 6 may currently be generated in a curved shape based on the yaw rate of the autonomous vehicle 10.

The control device 100 may check whether the front vehicle enters a preset third area (in a step S520).

Specifically, the control device 100 may determine whether the front vehicle 20 is spaced apart from the expected traveling trajectory of the autonomous vehicle 10 by a predetermined lateral distance or more, based on the position of the surrounding vehicle 30 located within the predetermined distance.

For example, referring to FIG. 6, the autonomous vehicle 10 is traveling along a curved road, and the expected traveling trajectory 11 is extending along a straight road. At this time, the front vehicle 20 is at a position of 20a after deviating from the trajectory, which corresponds to a position spaced apart from the surrounding vehicle 30 by a predetermined distance or more in the lateral direction. In this case, in order to accurately determine the spaced-apart position as in FIG. 4, any point in the front vehicle 20a and any point in the surrounding vehicle 30 may be set.

In a situation where the lane changes from a curved line to a straight line as shown in FIG. 6, when the position of the front vehicle 20 is spaced apart from the surrounding vehicle 30 adjacent to the expected traveling trajectory by a predetermined distance or more in the lateral direction, the control device 100 may determine that the front vehicle 20 maintains the traveling lane of the autonomous vehicle 10. This result may be attributed to the change from a curved road to a straight road.

Therefore, when it is determined that the front vehicle 20 has entered the third area, the control device 100 may continue to maintain the following control to follow the front vehicle 20 (in a step S530).

In contrast, when the front vehicle 20 does not enter the third area, i.e., when the lateral spaced-apart distance condition with reference to the surrounding vehicle 30 is not satisfied, the control device 100 may additionally determine whether the front vehicle 20 has entered a fourth area (in a step S540).

The control device 100 may determine that the front vehicle 20 has entered the fourth area when the position of the front vehicle 20 is spaced apart by less than a preset lateral distance with reference to the surrounding vehicle 30 positioned within a predetermined distance from the expected traveling trajectory.

In this case, since it is determined that the front vehicle 20b is positioned close to the surrounding vehicle 30 traveling on the same lane as the actual traveling lane of the autonomous vehicle 10, the control device 100 may consider that the existing front vehicle 20 has been changed to a new lane outside the current traveling path of the autonomous vehicle. Therefore, according to this, the control device 100 may no longer consider the front vehicle 20 as a target to follow and may terminate the following control on the vehicle (in a step S550).

Meanwhile, when the front vehicle 20a in the third area and the front vehicle 20b in the fourth area are positioned, they may all be spaced apart by a predetermined distance or more in the longitudinal direction with reference to the surrounding vehicle 30. In this case, unlike FIG. 4, it is difficult for the control device 100 to determine whether to continue the following only with the longitudinal information, and whether to continue the following may be determined through the lateral information.

When it is determined that the front vehicle has entered the fourth area, the control device 100 may consider the surrounding vehicle as a new front vehicle (i.e., a new target vehicle to follow) and determine whether the following condition is satisfied (in a step S560).

Specifically, the control device 100 may check whether the speed of the surrounding vehicle is less than or equal to a preset reference speed. In addition, the control device 100 may determine whether the time taken to determine whether to maintain the following control of the front vehicle exceeds a preset time limit. In addition, the control device 100 may also check whether the autonomous vehicle 10 maintains the lane stably without deviating from the lane in which it is currently traveling.

When at least one or more of these conditions are satisfied, the control device 100 may set the surrounding vehicle as the target vehicle for the new following control of the autonomous vehicle 10 (in a step S570). In contrast, when none of these conditions is satisfied, the control device 100 may postpone switching the following target or switch to a separate mode.

On the other hand, when it is determined that the front vehicle has entered neither the third area nor the fourth area (“NO”in the step S540), the control device 100 may control the autonomous vehicle 10 according to a preset policy or a user option (in a step S580).

The term ‘-unit’ as used in this embodiment refers to a software component or a hardware component such as an FPGA (field-programmable gate array) or an ASIC, wherein the ‘-unit’ performs certain roles. However, the term ‘-unit’ is not limited in meaning to software or hardware. A ‘-unit’ may be configured to reside in an addressable storage medium or configured to execute one or more processors. Thus, as an example, a ‘-unit’ includes components such as software components, object-oriented software components, class components, and task components, as well as processes, functions, attributes, procedures, subroutines, segments of program code, drivers, firmware, microcode, circuits, data, databases, data structures, tables, arrays, and variables. The functionality provided in the components and ‘-units’ may be combined into a smaller number of components and ‘-units’ or further separated into additional components and ‘-units’. Furthermore, the components and ‘-units’ may also be implemented to execute one or more CPUs within a device or a secure multimedia card.

While the embodiments of the present disclosure have been described above, it should be understood by those of ordinary skill in the art that various modifications and changes can be made to the present disclosure without departing from the spirit and scope of the disclosure as defined by the appended claims.

What is claimed is:

1. An autonomous vehicle control device comprising:
a memory configured to store at least one instruction; and
one or more processors connected to the memory,
wherein the at least one instruction is configured, when executed by the one or more processors, to cause the autonomous vehicle control device to:
generate an expected traveling trajectory of the autonomous vehicle based on a yaw rate of the autonomous vehicle being controlled to follow a front vehicle;
determine whether the front vehicle deviates from the expected traveling trajectory based on position information of the front vehicle;
determine, when the front vehicle deviates from the expected traveling trajectory, whether to maintain following control to follow the front vehicle based on the position information of the front vehicle and position information of a surrounding vehicle adjacent to the front vehicle, and
control the autonomous vehicle based on a result of the determination of whether to maintain the following control.

2. The autonomous vehicle control device of claim 1, wherein the at least one instruction is configured, when the following control to follow the front vehicle is terminated, to control the autonomous vehicle to follow the surrounding vehicle or determine whether to deactivate the following control.

3. The autonomous vehicle control device of claim 1, wherein the surrounding vehicle is a vehicle located on the expected traveling trajectory or a vehicle positioned within a preset distance from the expected traveling trajectory.

4. The autonomous vehicle control device of claim 1, wherein the at least one instruction is configured, when executed by the one or more processors, to cause the autonomous vehicle control device to:
when the autonomous vehicle is traveling in a section having a curvature less than or equal to a preset first curvature value and is scheduled to enter a section having a curvature greater than or equal to a second curvature value that is greater than the preset first curvature value,
maintain the following control to follow the front vehicle when the front vehicle is spaced apart by a distance less than or equal to a preset longitudinal distance with reference to a surrounding vehicle positioned within a predetermined distance from the expected traveling trajectory.

5. The autonomous vehicle control device of claim 1, wherein the at least one instruction is configured, when executed by the one or more processors, to cause the autonomous vehicle control device to:
when the autonomous vehicle is traveling in a section having a curvature less than or equal to a preset first curvature value and is scheduled to enter a section having a curvature greater than or equal to a second curvature value that is greater than the preset first curvature value,
terminate the following control when the front vehicle is spaced apart by a distance greater than a preset longitudinal distance with reference to a surrounding vehicle positioned within a predetermined distance from the expected traveling trajectory.

6. The autonomous vehicle control device of claim 5, wherein the at least one instruction is configured, when executed by the one or more processors, to cause the autonomous vehicle to follow the surrounding vehicle,
when the surrounding vehicle has a speed less than or equal to a predetermined speed;
when a time for determining whether to maintain the following control to follow the front vehicle exceeds a preset time limit; or
when the autonomous vehicle deviates from a lane in which the autonomous vehicle is currently traveling.

7. The autonomous vehicle control device of claim 1, wherein the at least one instruction is configured, when executed by the one or more processors, to cause the autonomous vehicle control device to:
when the autonomous vehicle is traveling in a section having a curvature greater than or equal to a preset second curvature value and is scheduled to enter a section having a curvature less than or equal to a first curvature value that is less than the preset second curvature value,
maintain the following control to follow the front vehicle when the front vehicle is spaced apart by a distance greater than or equal to a preset lateral distance with reference to a surrounding vehicle positioned within a predetermined distance from the expected traveling trajectory.

8. The autonomous vehicle control device of claim 1, wherein the at least one instruction is configured, when executed by the one or more processors, to cause the autonomous vehicle control device to:
when the autonomous vehicle is traveling in a section having a curvature greater than or equal to a preset second curvature value and is scheduled to enter a section having a curvature less than or equal to a first curvature value that is less than the preset second curvature value,
terminate the following control to follow the front vehicle when the front vehicle is spaced apart by a distance less than a preset lateral distance with reference to a surrounding vehicle positioned within a predetermined distance of the expected traveling trajectory.

9. The autonomous vehicle control device of claim 8, wherein the at least one instruction is configured, when executed by the one or more processors, to cause the autonomous vehicle to follow the surrounding vehicle,
when the surrounding vehicle has a speed less than or equal to a predetermined speed;
when a time for determining whether to maintain the following control to follow the front vehicle exceeds a preset time limit; or
when the autonomous vehicle deviates from a lane in which the autonomous vehicle is currently traveling.

10. The autonomous vehicle control device of claim 1, wherein the at least one instruction is configured, when executed by the one or more processors, to cause the autonomous vehicle control device to: output a notification via an input-output interface of the autonomous vehicle when the following control to follow the front vehicle is terminated, or when the surrounding vehicle is set as a new target vehicle for following control.

11. A method of controlling an autonomous vehicle, the method comprising:
generating an expected traveling trajectory of the autonomous vehicle based on a yaw rate of the autonomous vehicle being controlled to follow a front vehicle;
determining whether the front vehicle deviates from the expected traveling trajectory based on position information of the front vehicle;
in response to a determination that the front vehicle deviates from the expected traveling trajectory, determining whether to maintain following control of the front vehicle based on the position information of the front vehicle and position information of a surrounding vehicle adjacent to the front vehicle, and
controlling the autonomous vehicle based on a result of the determination of whether to maintain following control of the front vehicle.

12. The method of claim 11, further comprising: controlling the autonomous vehicle to follow the surrounding vehicle or determining whether to deactivate the following control, in response to termination of the following control of the front vehicle.

13. The method of claim 11, wherein the surrounding vehicle is a vehicle located on the expected traveling trajectory or a vehicle positioned within a preset distance from the expected traveling trajectory.

14. The method of claim 11, wherein determining whether to maintain the following control comprises:
in response to a determination that the autonomous vehicle is traveling in a section having a curvature less than or equal to a preset first curvature value and is scheduled to enter a section having a curvature greater than or equal to a second curvature value that is greater than the preset first curvature value, maintaining the following control of the front vehicle based on a determination that the front vehicle is spaced apart by a distance less than or equal to a preset longitudinal distance with reference to the surrounding vehicle.

15. The method of claim 11, wherein determining whether to maintain the following control comprises:
in response to a determination that the autonomous vehicle is traveling in a section having a curvature less than or equal to a preset first curvature value and is scheduled to enter a section having a curvature greater than or equal to a second curvature value that is greater than the preset first curvature value, terminating the following control based on a determination that the front vehicle is spaced apart by a distance greater than a preset longitudinal distance with reference to the surrounding vehicle.

16. The method of claim 15, further comprising:
following the surrounding vehicle based on a determination that the surrounding vehicle has a speed less than or equal to a predetermined speed and that at least one of the following conditions is satisfied: i) a time for determining whether to maintain the following control of the front vehicle exceeds a preset time limit; and ii) the autonomous vehicle deviates from a lane in which the autonomous vehicle is currently traveling.

17. The method of claim 11, wherein determining whether to maintain the following control comprises:
in response to a determination that the autonomous vehicle is traveling in a section having a curvature greater than or equal to a preset second curvature value and is scheduled to enter a section having a curvature less than or equal to a first curvature value that is less than the preset second curvature value, maintaining the following control of the front vehicle based on a determination that the front vehicle is spaced apart by a distance greater than or equal to a preset lateral distance with reference to the surrounding vehicle.

18. The method of claim 11, wherein determining whether to maintain the following control comprises:
in response to a determination that the autonomous vehicle is traveling in a section having a curvature greater than or equal to a preset second curvature value and is scheduled to enter a section having a curvature less than or equal to a first curvature value that is less than the preset second curvature value, terminating the following control of the front vehicle based on a determination that the front vehicle is spaced apart by a distance less than a preset lateral distance with reference to a surrounding vehicle positioned within a predetermined distance of the expected traveling trajectory.

19. The method of claim 18, further comprising:
following the surrounding vehicle based on a determination that the surrounding vehicle has a speed less than or equal to a predetermined speed and that at least one of the following conditions is satisfied: i) a time for determining whether to maintain the following control of the front vehicle exceeds a preset time limit; and ii) the autonomous vehicle deviates from a lane in which the autonomous vehicle is currently traveling.

20. The method of claim 11, further comprising:
outputting, via an input-output interface of the autonomous vehicle, a notification indicating that the following control of the front vehicle is terminated or that the surrounding vehicle is set as a new target vehicle for the following control.
